(19) United States
(12) Patent Application Publication
(10) Pub. No.: US 2006/0008695 A1
(43) Pub. Date: Jan. 12, 2006

(54) Fuel cell with in-cell humidification

(76) Inventors: Dingrong Bai, Dorval (CA); Jean-Guy Chouinard, Ville St-Laurent (CA); David Elkaim, Ville St-Laurent (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/886,936

(22) Filed: Jul. 9, 2004

(51) Int. Cl. H01M 8/02; H01M 2/08

(52) U.S. Cl. 429/38; 429/39; 429/35

(57) ABSTRACT

A fuel cell plate integrating an active flow field zone for carrying out electrochemical reaction and at least one humidification zone for humidifying reactant stream. The area of the humidification field is proportionally designed to the fuel cell active flow field so that an adequate humidity and temperature can be achieved for fuel cell systems that can have different capacities, under which resizing the humidifier would be otherwise required by the prior art designs.

### CROSS-REFERENCE TO RELATED APPLICATIONS

The application is related to commonly assigned co-pending U.S. patent application titled “Flow Field Plate for Use in Fuel Cells”, bearing agent docket number 16961-1US, the content of which is hereby incorporated by reference. The application is also related to commonly assigned co-pending U.S. patent application titled “Fuel Cell Stack with Even Distributing Gas Manifolds”, bearing agent docket number 16961-2US, the content of which is hereby incorporated by reference.

### TECHNICAL FIELD

The invention relates -to proton exchange membrane (PEM) fuel cells. Particularly, this invention relates to a humidification method and device to conduct moisture and heat exchange between humid cathode exhaust air and incoming dry air and/or fuel.

### BACKGROUND OF THE INVENTION

Proton exchange membrane fuel cells (PEMFCs) have received considerable attention lately as the primary low-temperature power generation devices useful in particular for zero-emission electric vehicles. A typical PEM fuel cell contains a proton conducting ion exchange membrane as the electrolyte material that is sandwiched between platinum loaded electrodes. The membrane material is a fluorinated sulfonic acid polymer commonly referred to by the trade name given to a material developed and marketed by DuPont—Nafion®, or XUS 13204.10 by Dow Chemical Company. The acid molecules are immobile in the polymer matrix. However, the protons associated with these acid groups are free to migrate through the membrane from the anode to the cathode, where water is produced. The electrodes in a PEMFC are made of porous carbon cloths doped with a mixture of Pt and membrane.

The performance and lifetime of a PEMFC are strongly dependent on the water content of the polymer electrolyte, so water-management in the membrane is critical for efficient operation. The conductivity of the membrane is a function of the number of water molecules available per acid site. If the membrane dries out, its resistance to the flow of protons increases, the electrochemical reaction occurring in the fuel cell can no longer be supported at a sufficient state, and consequently the output current decreases or, in the worst case, stops. In addition, the membrane dry-out can lead to cracking of the PEM surface and possible cell failure. For these reasons, PEM fuel cells commonly incorporate an element to humidify the incoming reactant streams.

On the other hand, if there is too much water, caused by whatever reasons such as more water brought in by the reactant streams or the accumulated water that is generated by the electrochemical reaction but not effectively removed from the fuel cell, the fuel cell electrodes can become flooded which also degrades the cell performance. Moreover, the nature of low temperature operation may result in a situation that the by-product water does not evaporate faster than it is produced. Consequently, this could lead to water accumulation and eventually electrode flooding if the water could not be removed effectively. For this reason, water removal and management has to be addressed properly in fuel cell designs.

Many methods have already been proposed for the humidification of process gases of fuel cells. Many systems designed in the prior art to keep the PEM hydrated employ external humidifiers to humidify the reactant gases. The external humidifier could be a motor driven enthalpy wheel as described in U.S. 2003/0091881 A1 to Eisler and Gutenmann, in which a porous desiccant material is rotated about a rotation axis to bring the moisture from humid stream to dry stream. The external humidifier could also be a device in which a water permeable membrane is used to transform the moisture from one side to another as described in US Pat. No. 2001/00125775 A1 to Katagiri et al. In some systems, humidification water is heated outside the fuel cell assembly by exhaust heat from the fuel cell itself, and the reactant gas is then exposed to this heated water and therefore humidifying the gas.

Using external humidifiers results in a requirement of an extra system component, which in turn leads to increased cost associated with equipment, assembly and maintenance. It also requires piping and insulation, and poses the possibility of a leak. Created by the humidifier, the pressure drop would be increased considerably, which leads to higher consumption of parasitic power and thus lowers the system performance. Furthermore, an external humidifier with a specific and defined capacity would have to be changed if the system is scaled up or scaled down, limiting the product usability. Moreover, a fuel cell system with external humidifier will be bulky and weighty.

There are some prior art designs for humidifying the reactant gases that employ one or two humidification sections comprising a set of humidifier plates located in either one or two ends of the fuel cell stack assembly, such as those described in U.S. Pat. No. 5,382,478 to C. Y. Chow and B. M. Wozniczka and in U.S. Pat. No. 6,602,625 B1 to X. Chen and D. Frank. In such designs, the incoming reactant gas is channeled over the humidifier plate through one side of a water permeable membrane of this section, and either a water stream or saturated fuel cell discharging stream flows through the other side of the membrane. Because the water permeable membrane is generally not electrically conductive, humidifier plates are typically located at the ends of the fuel cell assembly. As a result, the means for transporting the gas to humidification section(s) and from there to fuel cells in the stack can be complicated. In addition, the size of the humidifier section must be adjusted as the system capacity changes.

There are still other methods and devices for humidifying reactant gas for the operation of PEM fuel cells. U.S. Pat. No. 5,432,020 to F. Wolfram describes a method and a device for humidifying process gas for the operation of fuel cells, where water from an external supply line is sprayed into the process gas through a fine atomizing nozzle. A metered quantity of fine water droplets is injected into the gas supply line, by way of which the process air is humidified. If the fuel cell is operated under pressure, the process air generally has to be cooled after it has been compressed. EP 0,301,757 A2 to M. J. Frederick describes a fuel cell with an ion-conducting electrolyte membrane where water is injected into the anode side through an external supply line to humidify and cool the fuel cell by evaporation of a portion of both the product water and the supplied liquid water. WO 03107465 to A. Toro et al. describes a method for humidifying the reactant gas in which a cooling fluid, preferably liquid water, is injected into the reactant gas through a multiplicity of calibrated fluid injection holes on conductive bipolar plates. JP 7,176,313 to T. Toshihiro describes an arrangement comprised of a fuel cell and an external heat exchanger, where water supplied by an external supply line is evaporated by the heat extracted from the used air of the cell and used to humidify the air to be supplied to the cell. U.S. Pat. No. 6,106,964 to H. Voss et al. describes an arrangement of a PEM-fuel cell and a combined heat and humidity exchanger comprising a process gas feed chamber and a process waste gas chamber separated by a water-permeable membrane. The water and heat from the process waste gas flow are transferred to the process gas feed flow through the water-permeable membrane. U.S. Pat. No. 6,066,408 to N. G. Vitale and D. O. Jones discloses a cooler-humidifier plate that combines functions of cooling and humidification within the fuel cell stack assembly. Coolant on the cooler side of the plate removes heat generated within the fuel cell assembly, while heat is also removed by the humidifier side of the plate for use in evaporating the humidification water. On the humidifier side of the plate, evaporating water humidifies reactant gas flowing over a moistened wick. After exiting the humidifier side of the plate, humidified reactant gas provides needed moisture to the proton exchange membranes used in the fuel cell stack assembly.

Another prior art system, described in U.S. Pat. No. 5,534,363 to K. M. Sprouse and D. J. Natratil, involves the use of the wick to establish a physically direct connection between a fuel cell's anode membrane surface and a liquid water reservoir. Wicking action substantially ensures the cell's anode surface is continually bathed in water. Although this design can effectively eliminate the need for some of a conventional fuel cell system's pumps and/or compressors, the use of a wick, which is positioned against the anode side, necessarily reduces the surface area on the anode side of the fuel cell that may be contacted by hydrogen gas, and therefore reduces fuel cell electrochemical reaction performance. U.S. Pat. No. 20020106546 to T. Patterson and M. L. Perry describes a PEM fuel cell oxidant flow field plate having a substantial portion of the flow field formed of interdigitated reactant flow channels includes a humidification zone coextensive with an electrolyte dry-out barrier to allow humidification of the inlet reactant gas from adjacent water, such as coolant water flow channels and/or the anode. This art, in addition to proposing only interdigitated flow channels and humidifying using coolant water, connects the humidification channels and interdigitated channels directly and openly, which might result in difficulty in preventing gas leakage and crossover.

In the cases where external quality water is injected for humidifying, it adds additional cost associated with not only water treatment but also water itself. In some areas, it might not be affordable to fuel cell users for such large water consumptions. In the cases when the product water is used after it is recovered from the fuel cell system, it might be difficult or impossible to regulate the feedback portion of the product water. Furthermore, any contaminations in the product water, such as metal ions, are continually circulated, which can lead to an impairment of the cell and the water-permeable membrane during extended operation.

Therefore, there is a need for improving the already existing ways of humidifying fuel cells.

### SUMMARY OF THE INVENTION

The invention relates to a fuel cell plate integrating an active flow field zone for carrying out electrochemical reaction and at least one humidification zone for humidifying reactant streams. The area of the humidification field is proportionally designed to the fuel cell active flow field so that an adequate humidity and temperature can be achieved for fuel cell systems that can have different capacities, under which resizing the humidifier would be otherwise required by the prior art designs. The in-cell humidification provided in this invention simplifies the fuel cell system design and manufacturing, increases compactness and improves the fuel cell reliability. It also reduces the system cost by eliminating conventional external or internal humidifiers, and increases the system efficiency by reducing the parasitic power consumption due to reduced pressure drop and reduced heat losses from conventional humidifiers.

It is an object of the invention to provide a method and a device for humidifying the reactant gas stream. It is an object of the invention to provide a fuel cell system where membranes will not be dried out by the incoming gaseous reactants and that the reactant gases are delivered to the fuel cell at a desired humidity. It is also an object of the invention that the membranes are not subjected to undesirable drying out over a wide range of fuel cell operating conditions. It is still another object of the invention to provide a fuel cell system where the humidifier is automatically and proportionally scaled to meet the humidification requirement of any sized fuel cell systems.

More specifically, it is an object of the invention to integrate the active flow field with the humidification field on a single fuel cell plate. The humidification field coexists with the fuel cell active field, and the area of the humidification field is proportionally designed to the fuel cell active flow field so that an adequate humidity and temperature can be achieved. The in-cell humidification provided in this invention simplifies the fuel cell system design and manufacturing, increases compactness and improves the fuel cell reliability. It also reduces the system cost by eliminating conventional external or internal humidifiers, and increases the system efficiency by reducing the parasitic power consumption due to reduced pressure drop and reduced heat losses from conventional humidifiers.

To achieve the foregoing objects the present invention provides a fuel cell plate that includes an active area of electrochemical reaction channeled with appropriate configuration and covered with a membrane electrode assembly, and at least one area of humidification also having fluid paths and covered with a water permeable membrane but without catalysts. A source for incoming reactant gas is provided through a manifold to the humidification area on the anode or cathode plate or redirects from one plate to the other plate through at least one transporting manifold. The humidified stream flows through a transporting manifold to an entrance of the active area, from where the reactant gas is brought into contact with the MEA and undergoes electrochemical reaction.

The present invention also provides a humidification method in which the cathode exhaust air that is commonly saturated is used to provide the moisture source for humidifying incoming reactant gas. The cathode exhaust is brought to the humidification zone by employing another transporting manifold that redirects the gas flow from one plate to the other plate. Either the incoming stream or the cathode exhaust needs to dive from anode plate to cathode plate or vise versa. The communication between the active area and humidification area is by means of transporting manifolds in order to facilitate the prevention of gas leakage and crossover. The ratio of the humidification area to the active area is sized to provide suitable humidification condition on a single cell basis, so the ratio would remain proportional and the performance remains the same regardless of the changes in either operation conditions or the number of cells (i.e. the fuel cell system capacity), eliminating the need to reselect or resize the humidifier when the system is rescaled.

As a result of this design, heat carried by the cathode exhaust is well reserved and recovered. Benefiting from the in-cell humidification, there are no complicated manifold arrangements and gaskets as appeared in ends-located internal humidifier and no piping/fitting and their insulation as in the case of using external humidifiers. Once manufactured the plates with integrated in-cell humidification can be simply stacked to the desired number for any preferred power outputs, an obvious advantage of simplicity, flexibility and cost effectiveness.

According to a first broad aspect of the present invention, there is provided a fluid flow plate for a fuel cell, the plate comprising: an active area having a first inlet, a first outlet, and a first set of flow channels therebetween for carrying out electrochemical reactions; and a humidification area having a second inlet, a second outlet, and a second set of flow channels therebetween for humidifying fluid streams.

According to a second broad aspect of the present invention, there is provided a fluid flow plate for a fuel cell comprising: an active area covered with a catalytic membrane and having a first set of flow channels for carrying out electrochemical reactions; a humidification area covered with a water-permeable membrane and having a second set of flow channels for exchanging humidity between fluid streams; and at least one inlet and one outlet in fluid communication with one of the humidification area and the active area.

This plate can be the cathode plate or the anode plate. Depending on the design, the inlets and outlets are distributed differently, as will become clear in the description below.

The active area and humidification area may be on the same side of the plate, or on opposite sides of a same plate. Preferably, the flow channels are passages having parallel grooves to direct flow.

### BRIEF DESCRIPTION OF THE DRAWINGS

Further features and advantages of the present invention will become apparent from the following detailed description, taken in combination with the appended drawings, in which:

FIG. 1 is a general schematic of an in-cell humidification fuel cell plate according to one embodiment of the invention;

FIG. 2a is a schematic illustrating an anode plate with one transporting manifold and one humidification section according to one embodiment of the invention;

FIG. 2b is a schematic illustrating a cathode plate with one transporting manifold and one humidification section according to one embodiment of the invention;

FIG. 2c is a cross-section of the fuel cell according to one embodiment of the invention;

FIG. 3a is a schematic illustrating an anode plate with two transporting manifold and one humidification section according to a second embodiment of the invention;

FIG. 3b is a schematic illustrating a cathode plate with two transporting manifold and one humidification section according to a second embodiment of the invention;

FIG. 4a is a schematic illustrating an anode plate with first and secondary fuel distributing manifolds and one humidification section according to a third embodiment of the present invention;

FIG. 4b is a schematic illustrating a cathode plate with first and secondary fuel distributing manifolds and one humidification section according to a third embodiment of the present invention;

FIG. 5a is a schematic illustrating an anode plate with two humidification sections according to a fourth embodiment of the present invention;

FIG. 5b is a schematic illustrating a cathode plate with two humidification sections according to a fourth embodiment of the present invention;

FIG. 6A is a schematic illustrating a membrane for the two sections of the plate;

FIG. 6B is a schematic illustrating two membranes, one for each section;

FIG. 7A is a schematic illustrating an anode plate with a gasket network;

FIG. 7B is a schematic illustrating a cathode plate with a gasket network; and

FIG. 7C is a sectional view of the back side of section A of the anode plate of FIG. 7A.

It will be noted that throughout the appended drawings, like features are identified by like reference numerals.

### DETAILED DESCRIPTION OF THE PREFERRED EMBODIMENT

Throughout the description, the term “membrane electrode assembly” (MEA) will be understood as consisting of a solid polymer electrolyte or ion exchange membrane disposed between two electrodes formed of porous, electrically conductive sheet material, typically fiber paper but not limited thereto. The MEA contains a layer of catalyst, typically in the form of platinum, at each membrane/electrode interface to induce the desired electrochemical reaction. Suitable MEA materials can include those commercially available from 3M, W. L. Gore and Associates, DuPont and others. For the present invention, a portion of the membrane facing each plate is non-catalytic, water permeable, and gas impermeable in order to allow humidity exchange between fluid streams flowing through the humidification area of the cathode plate and the humidification area of the anode plate. Preferably, the water permeable membrane is impermeable to the reactant gases to prevent reactant portions of the supply and exhaust streams from inter-mixing. Suitable membrane materials include cellophane and perfluorosulfonic acid membranes such as Nafion®, which is a suitable and convenient water permeable humidification membrane material in such applications.

Exemplary embodiments of the invention will be described herein in the environment of an intended use of PEM fuel cells that utilize either hydrogen or hydrogen-rich reformate as an anode gas and an oxygen containing air as a cathode gas. The exemplary embodiments of the invention will be primarily described for humidifying cathode air, however, it may be used for humidifying anode fuel, or both cathode air and anode fuel, in which case, two humidification zones will typically be located on the plates and appropriate fluid connection will be provided. Consequently, the invention should not be regarded as limited to the exemplary embodiments.

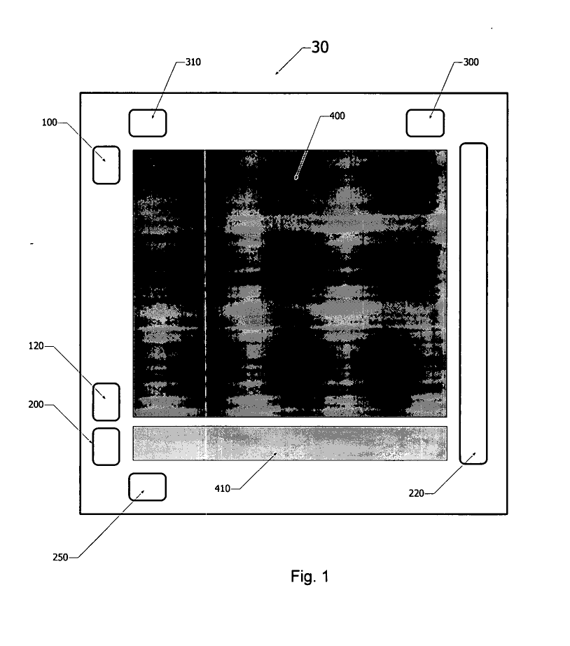

In accordance with the principles of the present invention, a fuel cell is provided with an appropriate fluid flow plate that is operable to distribute a reactant gas to a membrane electrode assembly (MEA) of the fuel cell, and humidify the reactant gas prior to being sent to contact with the MEA. The fluid flow plate 30 of the present invention, as generally depicted in FIG. 1, has at least two areas, one termed as active area 400 and the other as humidification area 410. It may also be divided into three areas in which one serves as active area and the other two as humidification areas for humidifying cathode air and anode fuel, respectively. The plate 30 has manifold openings, 100, 120, 200, 250, 300 and 310, for effectively distributing and connecting the fluid streams of anode, cathode and coolant. There is at least one fluid-transporting manifold 220 to connect the outlet of humidification zone 410 to the entrance of the active zone 400. The active zone comes to contact with the catalysts loaded membrane, and has flow channels of any desired pattern (e.g. parallel, serpentine or any other kind). The humidification zone also contacts with a membrane that preferably is the same membrane as the active area but without catalysts loaded. There are also flow channels in the humidification zone, which could be structurally similar to the active area. The size of the humidification area, preferably about 10-40% of the active area, is set to provide appropriate humidification of incoming reactant gas on a single cell basis. The structure of the humidification zone, active zone, manifolds and transporting path are all preferably designed to facilitate installation of gaskets to prevent gas leaking and crossover.

Clearly, integration of the humidification and active electrochemical reaction zones on a single fuel cell plate will eliminate use of external or ends-located humidifiers, and thus eliminate all associated needs of piping and insulation. In addition to its simplicity and compactness, it is important that the present invention will considerably enhance the ability of fuel cell scale up or down.

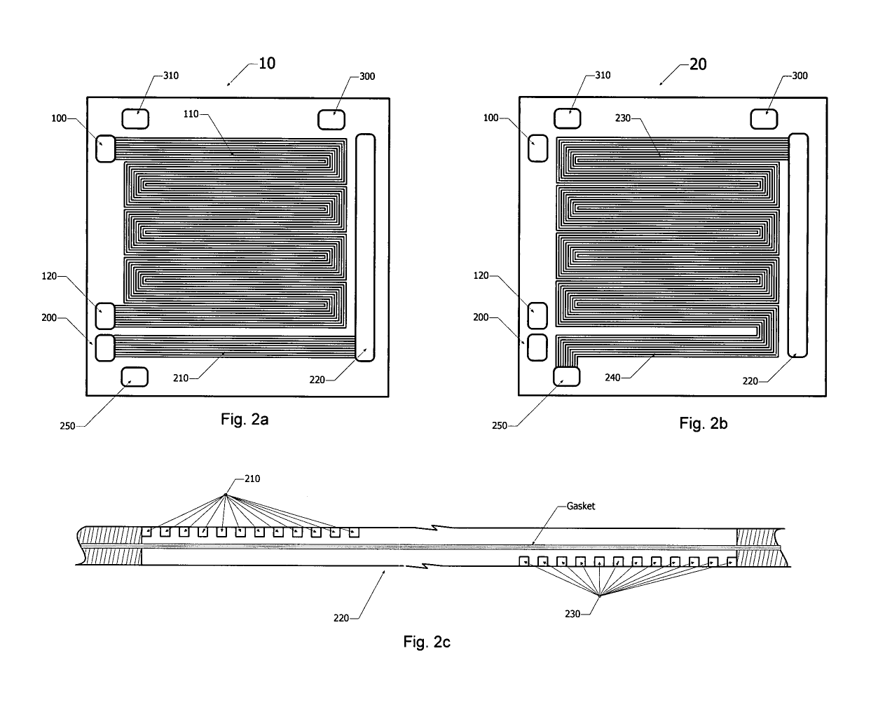

Now referring to FIG. 2 for one of the preferred embodiments according to the present invention. FIG. 2a provides an anode plate 10, on which a fuel (hydrogen or hydrogen rich reformate) is introduced through a manifold opening 100, which fluidly connects to the flow channels 110 on the active area 400 of FIG. 1. The flow channels illustrated herein are serpentine, but as mentioned earlier, this is only for illustration purposes because in fact they can be any desirable patterns. The fuel stream exits the active area to a manifold opening 120. On the anode plate 10, the cathode air is brought in through a manifold 200 and fluidly connected to flow channels 210 on the area corresponding to the humidification zone 410 of FIG. 1. The cathode air then comes to a transporting manifold 220, which extends through the stack but will be blocked by the end plates. This has been schematically illustrated in FIG. 2c. The transport manifold has two functions, one as a fluid communication means to transport the gas from exit of the humidification zone to the entrance of the active zone, and the other as a mechanism to redirect the gas flow from anode plate (one side of gasket) to the cathode plate (the opposite side of gasket) while facilitating the installation of gaskets and preventing potential gas crossover. The use of transporting manifolds also has the potential benefits of increasing the effective use of the plate area and uniformly redistributing the reactant stream. On the cathode plate 20 of FIG. 2b, the humidified air, being redirected from anode plate 10 through the transporting manifold 220, enters the flow channels 230 of the active area 400 of FIG. 1, and is fluidly connected to the fluid channels 240 of the humidification area 410 of FIG. 1. In such a way, over the humidification area 410, the incoming air is flowing over the anode plate 10 on one side of a water permeable membrane and the saturated cathode exhaust air is flowing over the cathode plate 20 on the opposite side of the membrane, which has been schematically illustrated in FIG. 2c. As such an arrangement, the incoming air flows counter-currently with the cathode exhaust, and transfers of moisture and heat from hot and saturated cathode exhaust to cooler and dry incoming air are accomplished.

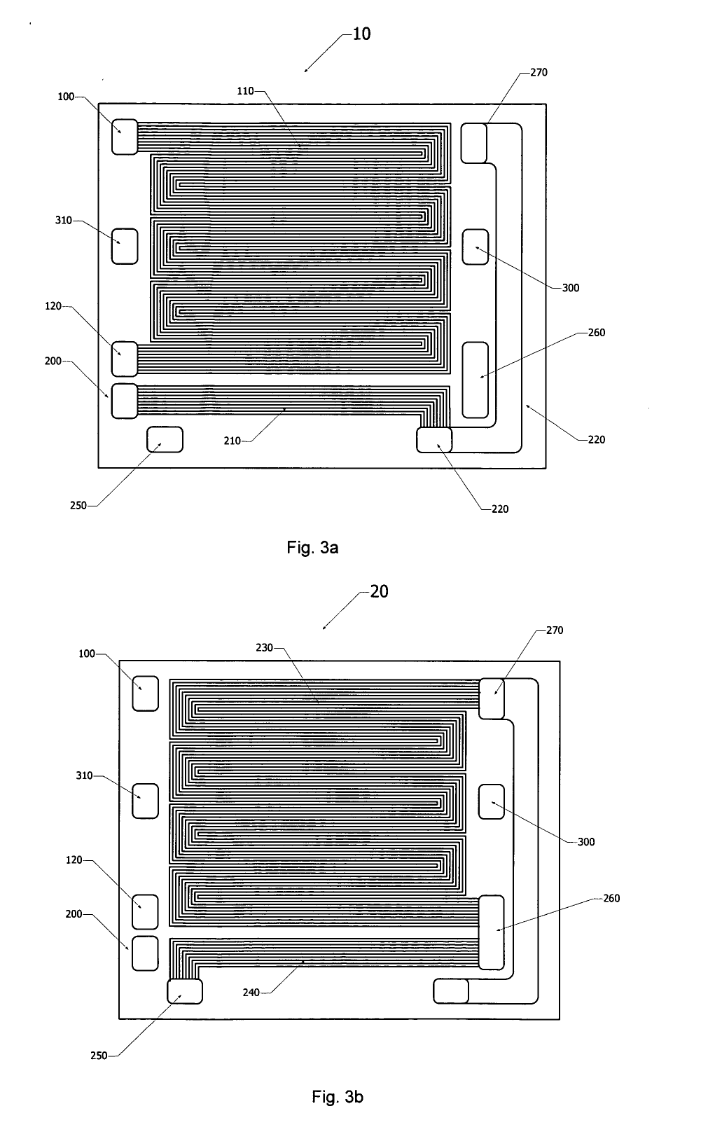

FIG. 3 depicts a variant of the preferred embodiments illustrated in FIG. 2. As shown in FIG. 3, there are two transporting manifolds, 220 and 260, on the anode plate 10 and cathode plate 20. The transporting manifold 220 again transports and redirects the humidified air stream from the humidification zone to the active zone, while the transporting manifold 260 transports and redirects the cathode exhaust air from the active area to the humidification area. The addition of the transporting manifold 260, compared to the embodiment shown in FIG. 2, is to further facilitate the installation of a gasket for preventing gas leaks and crossover.

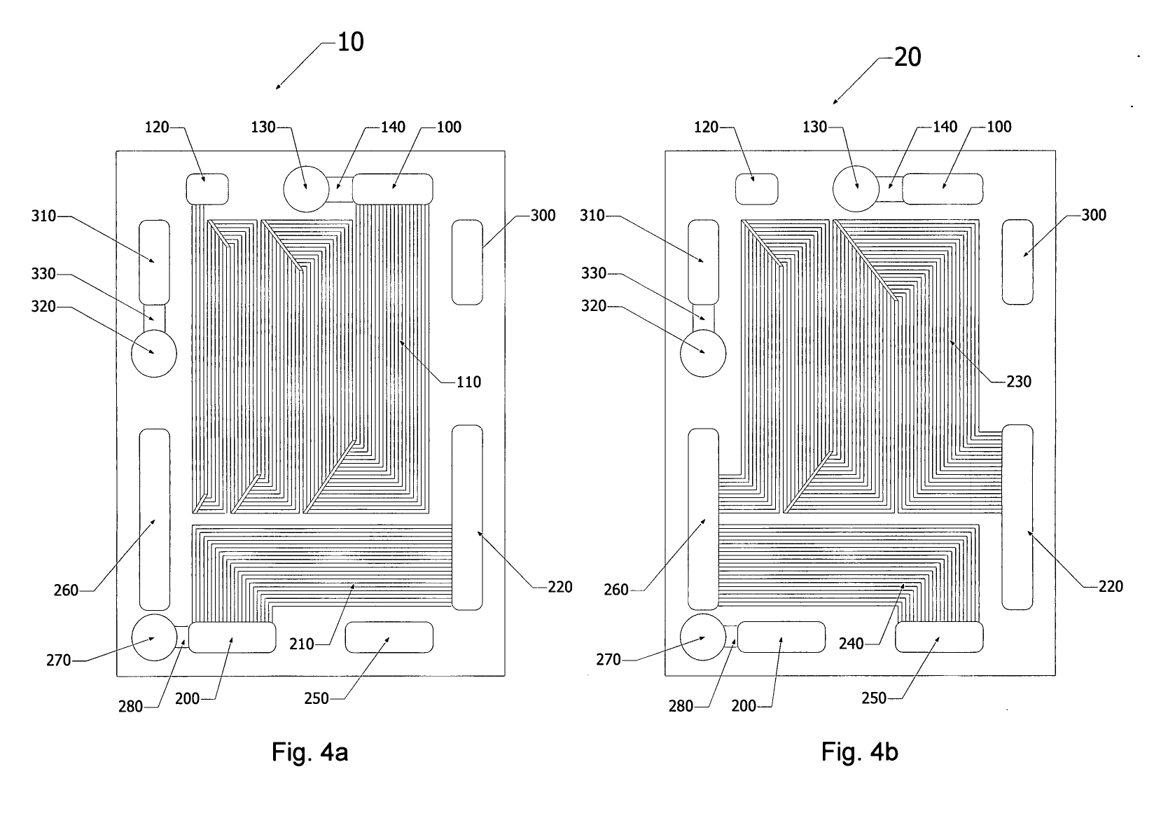

Reference will now be made in detail to another preferred embodiment of the present invention, as schematically illustrated in FIG. 4a and FIG. 4b. FIG. 4a provides an anode plate 10, on which a fuel (hydrogen or hydrogen rich reformate) is introduced through a first fuel manifold opening 130, which fluidly connects to a secondary fuel distributing manifold 100 through a fluidly connecting path 140. The fuel is redistributed from the secondary manifold 100 into the first path of the fluid flow channels 110, and the residual fuel exits the active area to the outlet manifold 120. The advantage of using first and secondary manifolds is to achieve uniform gas distribution into each individual cell in a fuel cell stack comprising a plurality of cells. The details of this unique manifold design have been disclosed in co-pending US patent application bearing agent docket number 16961-2US, which is hereby incorporated by reference.

The number of flow channels is the largest for the first path and then reduces stepwise towards downstream. The reduction rate in the number of flow channels is determined in accordance with the reactant gas consumption rate due to progressive electrochemical reaction. The ratio of the number of flow channels of the first path to that of the last path corresponds to either the hydrogen or the fuel gas consumption rate. There is a mechanism provided to rejoin and redistribute the gas between upstream and downstream paths. The details of this unique flow field design have been disclosed in co-pending US patent application bearing agent docket number 16961-1US, which is hereby incorporated by reference.

On the anode plate 10, it is again divided into at least two areas, namely, an active area and a humidification area. The incoming cathode air first enters into a first manifold opening 270, which is fluidly connected to a secondary manifold 200 through a path 280. The cathode air is then redistributed into flow channels 210, which are distributed over the humidification area. The number of flow channels 210 can be determined so that a low enough pressure drop is achieved for lowering parasitic power consumption associated with the gas compression and delivery. Fluidly connected to the secondary manifold 200, the incoming air is distributed into the flow channels 210 over the humidification zone, which is opposite to the humidification zone on the cathode plate 20. The humidified air exits the humidification zone into a transporting manifold 220, which extends to the fuel cell active zone and redirects the air into the entrance of the active flow field on the cathode plate 20.

On the cathode plate 20, as shown in FIG. 4b, the humidified air enters the first flow path 230 from the transporting manifold 220. As for the anode plate, the number of flow channels gradually reduces one path after another, and the ratio of the flow channels of the first path to the last path corresponds to the oxygen or air consumption rate. The depleted cathode air exits the active flow field into the second transporting manifold 260, by which the cathode exhaust is redistributed into the humidification flow channels 240. In this case the exhaust flows co-currently to the incoming air on the opposite side of the water permeable membrane. The numbers of the flow channels 240, can be the same or different from the flow channels 210 on the anode plate of FIG. 4a, but would cover the same flow area. The number of flow channels 240 will be larger than that of the last path of flow channels 230, which is preferred because it will slow down the cathode exhaust flow rate over the humidification area to allow sufficient moisture transfer.

For illustration purpose, on the anode plate 10 and the cathode plate 20, the first and secondary coolant inlet manifold openings 320, 310 as well as coolant outlet manifold opening 300 are also indicated.

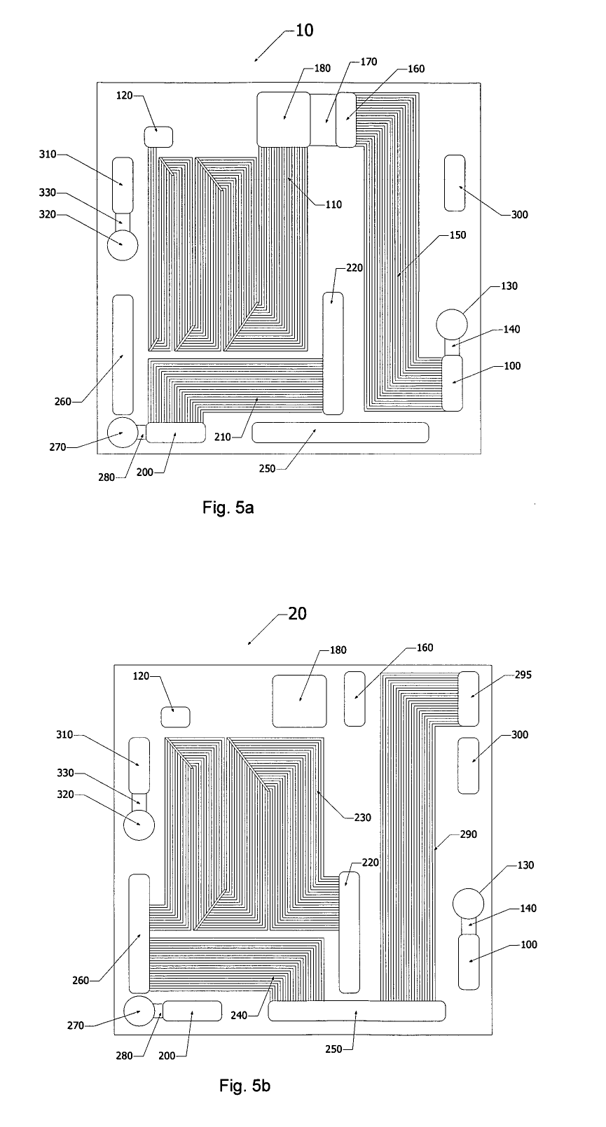

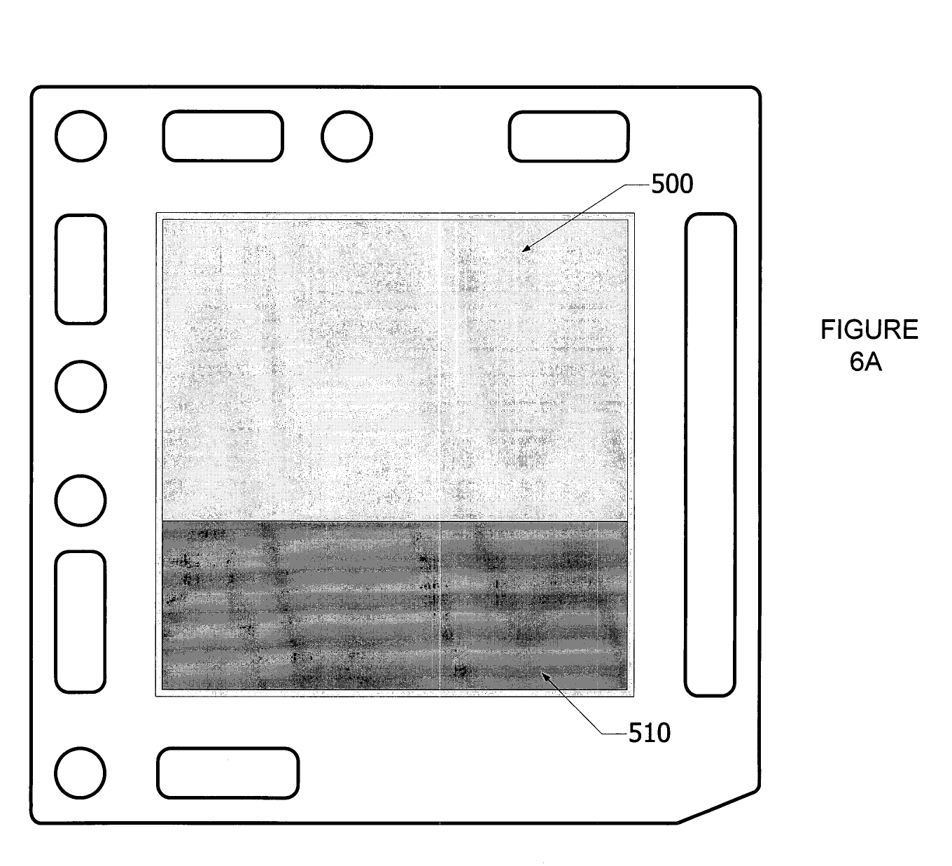

Now referring to FIG. 5 for yet another preferred embodiment according to the present invention, in which a second humidification zone 150, 290 is added for humidifying the fuel stream, in addition to the first humidification zone 210, 240 for humidifying the air stream. Humidifying fuel stream becomes essential especially when dry hydrogen is used as fuel considering the fact that no water is produced at anode side and thus the membrane can be easily dried out.

FIG. 5a illustrates an exemplary embodiment of the anode plate 10, on which it is divided into three areas, namely, an active area for carrying out electrochemical reactions, a first humidification zone for humidifying an air stream and a second humidification zone for humidifying a fuel stream. Similar to FIG. 4a, the incoming cathode air enters into a first manifold opening 270, which is fluidly connected to a secondary manifold 200 through a path 280. The cathode air is then redistributed into flow channels 210, which are distributed over the first humidification area. Leaving the first humidification zone, the humidified incoming cathode air flows into a first transporting manifold 220, through which the air is redistributed into the entrance of the cathode active flow field 230 on the cathode plate 20 as shown in FIG. 5b. The hydrogen fuel is introduced through first manifold opening 130, which fluidly connects to secondary fuel distributing manifold 100 through a fluidly connecting path 140. The hydrogen fuel is redistributed from the secondary manifold 100 into the flow channels 150 of the second humidification zone. The hydrogen fuel will receive moisture from the saturated cathode air flowing opposite the water permeable membrane on the cathode plate. The humidified hydrogen fuel, exiting the second humidification zone enters into the first path of the anode active flow channels 110 through transporting manifolds 160 and 180 connected by a fluidly communicating path 170. The residual hydrogen fuel exits the active zone to outlet manifold 120.

On the cathode plate 20 illustrated in FIG. 5b, the humidified air enters the first flow path 230 from the transporting manifold 220. The depleted cathode air exits the active flow field into second gas transporting manifold 260, by which the cathode exhaust is redistributed into the first humidification flow channels 240, over which the moisture and heat is transferred to the incoming air flowing on the opposite side of the water permeable membrane on the anode plate 10. The increased flow area of flow channels 240 compared to that of the last flow channels 230 slows down the cathode exhaust flow rate over the humidification area to allow sufficient moisture transfer. After the first humidification zone, the exhaust air is sent to the second humidification zone through a transporting manifold 250, which redistributes the exhaust air to flow channels 290. Over this area, the moisture and heat transfer to the hydrogen fuel flowing over the flow channels 150 on the anode plate 10 takes place. The cathode exhaust air finally leaves the fuel cell stack through an output manifold 295.

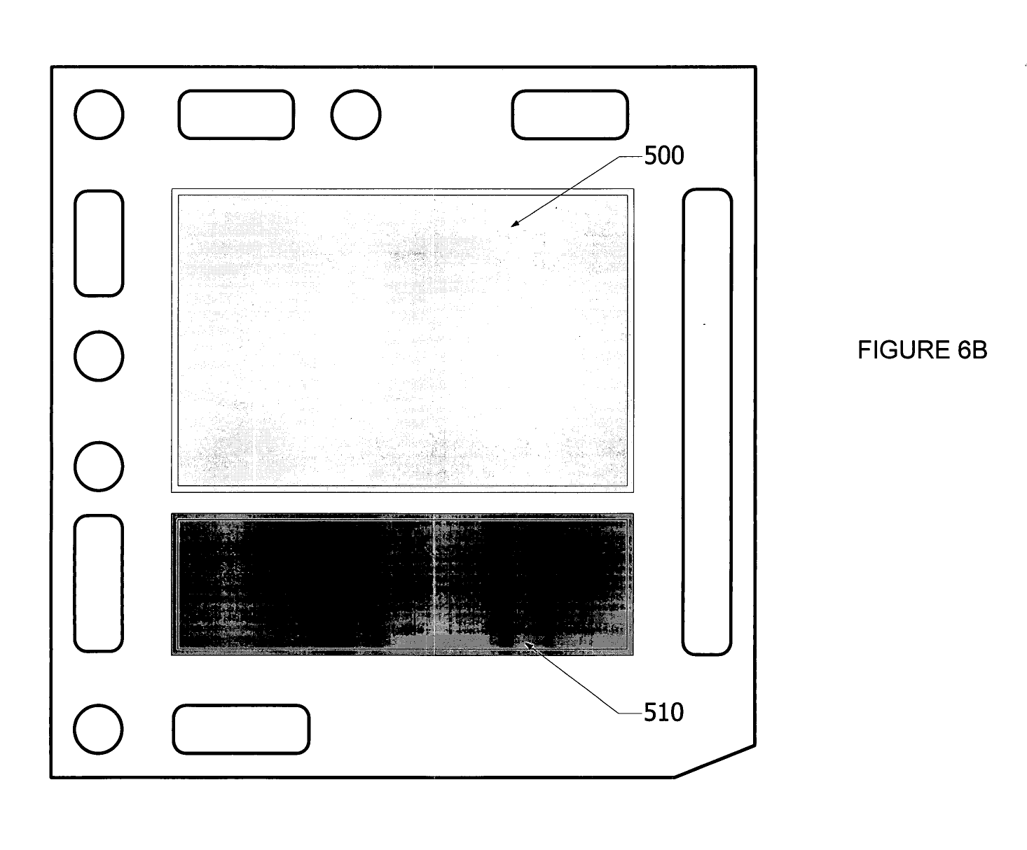

FIGS. 6A and 6B are illustrations of possible embodiments for the membrane sandwiched in between the anode and cathode plates of the fuel cell. A water permeable membrane 510 covers the humidification area 410 of the plate, while a catalytic membrane 500 covers the active area 400 of the plate. The water permeable membrane 510 is made from a material which is thermally conductive and water permeable but substantially gas impermeable. Suitable membrane materials include cellophane or perfluorosulfonic acid membranes such as Nafion®, which allow the passage of water vapor but are substantially impermeable to oxygen and hydrogen. In FIG. 6A, a common membrane is used and the portion corresponding to the active reaction zone is coated with the catalyst. In FIG. 6B, an MEA and a water permeable membrane are placed separately between the plates and the two are joined by a sub-gasket. For this, the MEA (with catalyst layers) and membrane can be used separately and cut to appropriate sizes to be assembled accordingly.

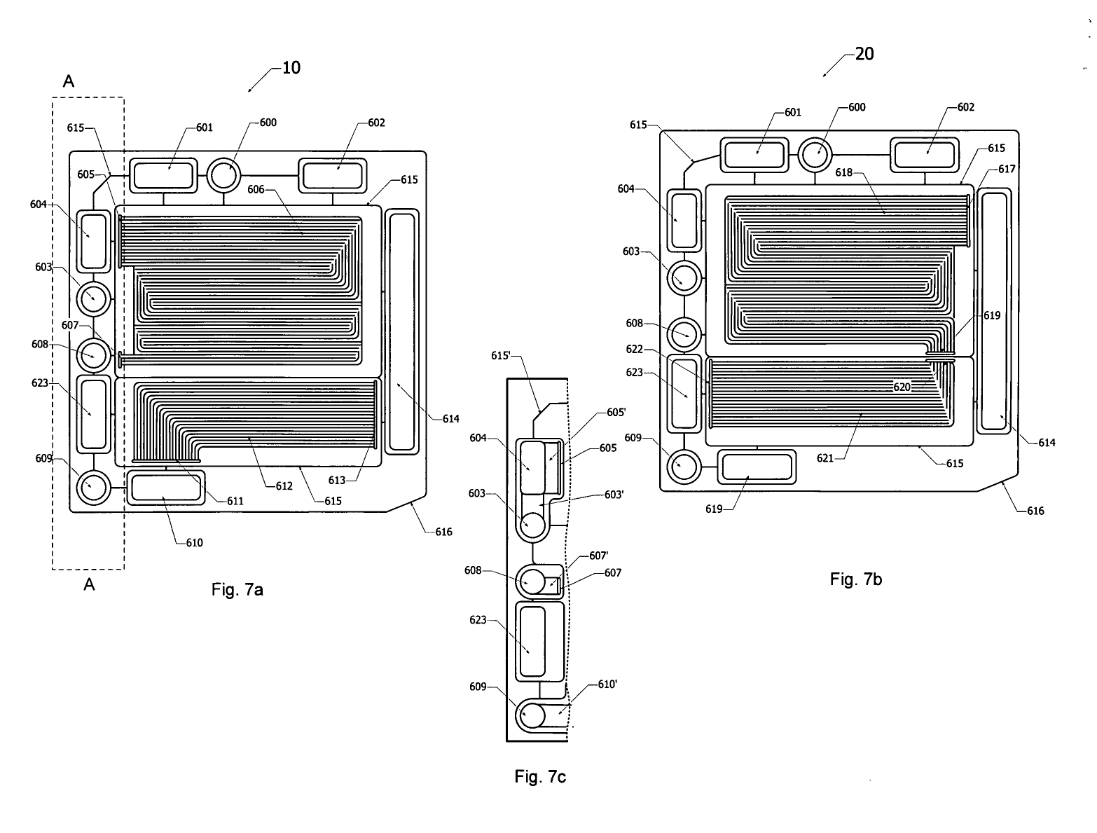

In alternative embodiments of the present invention, the cathode side and anode side may be switched. In this situation, the incoming air can enter into the humidification zone on the cathode plate and the cathode exhaust can be redirected into the humidification zone on the anode plate. The fluid connection between the manifold and flow channels can be arranged on the same side of the plate as illustrated in FIGS. 1 to 6, or on the different sides of the plate. In the latter case, the reactant will be first directed from the manifold to a slot on the back side of the plate, where stack coolant flow channels may be arranged. The slot penetrates the plate and brings the reactant to the front side of the plate and eventually redistributes the reactant into flow channels. Such a flow arrangement is advantageous in terms of gas leakage prevention especially when O-ring type gaskets are used, as exemplarily illustrated in FIG. 7.

In FIG. 7a and FIG. 7b, there are flow channels on the anode plate 10 and the cathode plate 20 over the areas corresponding to active area 400 (606 and 618) and humidification area 410 (612 and 621). There is provided a gasket network 615 to facilitate installation of O-ring type gaskets to prevent gas leakage and inter-mixing. The gasket network surrounds the active area and humidification area as well as all manifold holes. Hydrogen or hydrogen-rich reformate enters first through a first fuel distribution manifold 603, which is fluidly connected to a second manifold 604 through a connection path 603′ on the backside of the plate 10, as shown in FIG. 7c. The fuel then flows through a path 605′ to a slot 605, from where the fuel penetrates through the plate 10 to the front side (FIG. 7a), which successively connects to a plurality of flow channels 606. The depleted anode gas exits the active area at a second slot 607, and through which the gas is directed to the backside of the plate 10. On the backside of the plate 10, as shown in FIG. 7c, the depleted anode gas exits at an outlet manifold hole 608 through a fluid connection path 607′. On the backside of the plate, a second gasket network 615′ can also be provided. The incoming cathode air enters the first manifold 609 through a fluid connection path 610′ and is directed to a second manifold 610 on the backside of the anode plate 10. Being directed from a plate-penetrating slot 611, the incoming cathode air flows into a plurality of flow channels 612 on the front side of the anode plate 10 over the humidification area 410. The humidified air flows into a transporting manifold 614 through another plate-penetrating slot 613. Fluidly connected on the backside of the cathode plate 20, the humidified cathode air is directed to a plurality of flow channels 618 on the front side of the cathode plate 20 through a plate-penetrating slot 617. The depleted cathode air exits into a slot 619 and dives to the backside. On the backside of the cathode plate 20, the slot 619 fluidly connects to the slot 620 (not shown) and the depleted air is eventually directed to an outlet manifold 623 after flowing successively through a plurality of humidification flow channels 621 and diving through a slot 622 to the backside of the cathode plate 20.

It should be understood that the forgoing description is intended to illustrate and not limit the scope of the invention, which is defined by the appended claims.

We claim:

1. A fluid flow plate for a fuel cell, the plate comprising:
an active area having a first inlet, a first outlet, and a first set of flow channels therebetween for carrying out electrochemical reactions; and
a humidification area having a second inlet, a second outlet, and a second set of flow channels therebetween for humidifying fluid streams.

2. A fluid flow plate as claimed in claim 1, wherein said first set of flow channels comprises a series of passages having parallel grooves thereon.

3. A fluid flow plate as claimed in claim 2, wherein said second set of flow channels comprises a series of passages having parallel grooves thereon.

4. A fluid flow plate as claimed in claim 2, wherein said series of passages are in a serpentine pattern.

5. A fluid flow plate as claimed in claim 4, wherein a number of said grooves reduces stepwise toward downstream for each successive passage in said active area.

6. A fluid flow plate as claimed in claim 5, wherein said passages are interconnected by a header providing a substantially even redistribution of fluid flow received from grooves of one passage to grooves of a next passage.

7. A fluid flow plate as claimed in claim 4, wherein said first set of flow channels comprises at least three passages.

8. A fluid flow plate as claimed in claim 3, wherein said second set of flow channels comprises two passages.

9. A fluid flow plate as claimed in claim 1, wherein said humidification area is about 10% to 40% of said active area.

10. A fluid flow plate as claimed in claim 1, further comprising a second humidification area having a third inlet and fluidly connected to said active area.

11. A fluid flow plate as claimed in claim 1, wherein said active area and said humidification area are on a same side of said plate.

12. A fluid flow plate for a fuel cell comprising:
an active area covered with a catalytic membrane and having a first set of flow channels for carrying out electrochemical reactions;
a humidification area covered with a water-permeable membrane and having a second set of flow channels for exchanging humidity between fluid streams; and
at least one inlet and one outlet in fluid communication with one of said humidification area and said active area.

13. A fluid flow plate as claimed in claim 12, wherein said catalytic membrane and said water-permeable membrane are joined by a sub-gasket.

14. A fluid flow plate as claimed in claim 12, wherein said catalytic membrane and said water-permeable membrane are a common membrane, and wherein a portion covering said active area is coated with a catalyst.

15. A fluid flow plate as claimed in claim 12, wherein said at least one outlet is connected to said humidification area.

16. A fluid flow plate as claimed in claim 12, wherein said at least one outlet is connected to said active area.

17. A fluid flow plate as claimed in claim 12, wherein said second set of flow channels comprises a series of passages having parallel grooves thereon.

18. A fluid flow plate as claimed in claim 17, wherein said first set of flow channels comprises a series of passages having parallel grooves thereon.

19. A fluid flow plate as claimed in claim 18, wherein said series of passages are in a serpentine pattern.

20. A fluid flow plate as claimed in claim 19, wherein a number of said grooves reduces stepwise toward downstream for each successive passage in said active area.

21. A fluid flow plate as claimed in claim 20, wherein said passages are interconnected by a header providing a substantially even redistribution of fluid flow received from grooves of one passage to grooves of a next passage.

22. A fluid flow plate as claimed in claim 18, wherein said first flow channel comprises at least three passages.

23. A fluid flow plate as claimed in claim 12, wherein said humidification area is about 10% to 40% of said active area.

24. A fluid flow plate as claimed in claim 12, further comprising a second humidification area having a third inlet and fluidly connected to said active area.

25. A fluid flow plate as claimed in claim 12, wherein said active area and said humidification area are on a same side of said plate.
